(19) United States
(12) Patent Application Publication
(10) Pub. No.: US 2022/0028022 A1
(43) Pub. Date: Jan. 27, 2022

(54) OPTIMIZED LOGISTIC PLANNING

(71) Applicant: Windigo Logistics, Inc., Maple Grove, MN (US)

(72) Inventor: Jeffrey Eul, St. Paul, MN (US)

(21) Appl. No.: 17/386,419

(22) Filed: Jul. 27, 2021

Related U.S. Application Data
(60) Provisional application No. 63/057,279, filed on Jul. 27, 2020.

(51) Int. Cl. G06Q 50/28; G06Q 10/04; G06Q 10/06; G06F 16/901; G06F 16/29; G01C 21/34

(52) U.S. Cl. CPC G06Q 50/28; G06Q 10/047; G06Q 10/06313; G01C 21/3453; G06F 16/9024; G06F 16/29; G06Q 10/06315

(57) ABSTRACT

A list of containers that each contain items is received. A list of the items is received and, for each item, data specifying which of the containers contains the item. A starting location is received. Container constraints that specify at least one condition in which at least one container is inaccessible is received. Delivery constraints that specify at least one condition that must be true for at least one item to be delivered are received. For each container, starting and ending locations are received and a sub-route corresponding to the container that specifies a delivery route to be followed to deliver each item in the container is generated. The sub-route for each container is compiled into a logistics route specifying a route a delivery route to be followed to deliver all items in all containers.

### CROSS-REFERENCE TO RELATED APPLICATIONS

This applications claims priority to, and the benefit of, Provisional Application No. 63/057,279, filed Jul. 27, 2021 entitled “OPTIMIZED LOGISTIC PLANNING”, the entirety of which is incorporated herein by reference.

### TECHNICAL FIELD

This document generally describes an information system capable of optimizing logistics planning, such as automatically generating optimal delivery routes for a logistics carrier given various operational constraints.

### BACKGROUND

Logistics and planning systems have been designed to make automated determinations related to the shipment and delivery of goods by logistics carriers, such as FedEx, UPS, and the US Postal Service. For example, logistics and planning systems have been developed to place items (e.g., packages, shipments, pallets) into groups that are designed to optimize the delivery of these items. For example, these groups can be based on delivery destinations for the items in the groups being located near each other so that the items in the group can be delivered more efficiently.

### SUMMARY

The disclosed technology generally provides optimized logistics plans for logistics problems that include one or more operational constraints (e.g., required bin sequence for delivery involving multiple bins, specific delivery or pickup time for particular location), such as providing a delivery plans for logistics carriers (e.g., trucks, planes, boats, planes, autonomous vehicles) that have delivery items parceled into separate units (e.g., containers, bins, boxes, shelves) that are delivered as a group. For example, a delivery truck (e.g., FedEx truck) may include several different bins of packages that are designed to be delivered in a particular sequence, with all the packages in the first bin being delivered first, then all of the packages in the second bin, and so on until all of the bins have been delivered and the route is completed (same can apply for trucks doing pickups, and/or trucks doing pickups and deliveries). Such bin-based groupings of packages, as well as the specified sequence for delivery of the bins (e.g., deliver bin 1 first, then bin 2, and so on), can have operational constraints that are fixed, yet the ordering of delivery of packages within each bin may be unspecified or sub-optimal. The disclosed technology can provide optimal route planning taking into account such operational constraints, which can include providing a sequence for delivering the packages within each bin, including identifying the starting package and the ending package for each bin. Such starting and ending package for bins can designate transitions between bins, which can additionally be optimized, for instance, to reduce distances travelled and/or time to complete delivery actions for each bin, for multiple bins, for all bins, and/or for the entire truck. Optimization may be a strict mathematical optimization for which not superior alternative is possible, or may be a more general optimization that is better than many alternatives.

Bin sequences can be one example of logistics constrains that are being solved for to generate optimal logistics plans (e.g., optimal delivery routes, optimal pickup routes, optimal routes with combined delivery and pickup). Additional and/or alternate logistics constraints can be imposed upon the logistics planning optimization. For example, particular delivery and/or pickup time windows may be imposed for some items, such as a requirement to deliver a particular package by noon or to pickup a package between 2 pm and 4 pm.

Optimization can be performed based on any of a variety of factors, such as minimizing distance travelled, minimizing time to complete all operations, minimizing costs for delivery (e.g., taking into account labor and equipment costs), and/or combinations thereof. Optimization can be performed for the entire load (e.g., truck), and/or for individual bins contained within the load. Selecting an optimal route for a load may, in some instances, involve selecting a sub-optimal load for a particular bin. For example, selecting a route for a bin that includes the best starting and ending point may be less efficient (e.g., take longer to complete, require longer distance travelled) than an optimal route for just that bin (not taking into account transitions to other bins), yet may be more efficient in for the entire delivery route across all bins because it optimizes transitions between bins (e.g., minimizes travel time and/or distance between first bin ending point and second bin starting point, and between second bin ending point and third bin starting point).

In some instances, one or more of the logistics constraints may be removed and solved for by this technology. For example, in instances where bin orders are not specified and/or where one or more portions of the bin sequences are available to be modified, the disclosed technology can additionally determine optimal bin sequencing for the portions that are available for planning. In another example, in instances where the grouping of items into bins can be modified, optimal bin groupings can additionally be determined.

The disclosed technology can additionally and/or alternatively detect anomalies in the operational constraints that can be flagged for correction and used to modify the operational constraints. For example, for some logistics carriers, the grouping of items into bins and the sequencing of bins may be performed at an earlier time and then items may be added to and/or removed from the bins. As a result, items may occasionally be added to bins that are sub-optimal for including in a particular group, and may either be better reassigned to another group within the load (e.g., truck) or to another load for delivery. Anomalies can be detected for individual items, for groups of items, and/or for sequences of bins.

In one implementation, a system can be used for determining a logistics route. The system can include one or more processors. The system can include computer memory storing instructions that, when run by the processors, cause the processors to perform operations. The operations include receiving a list of containers that each contain items; receiving a list of the items and, for each item, data specifying which of the containers contains the item; receiving a starting location, receiving container constraints that specify at least one condition in which at least one container is inaccessible; receiving delivery constraints that specify at least one condition that must be true for at least one item to be delivered; for each container: identifying starting and ending locations; and generating a sub-route corresponding to the container that specifies a delivery route to be followed to deliver each item in the container; and compiling the sub-route for each container into a logistics route specifying a route a delivery route to be followed to deliver all items in all containers. Other implementations can include methods, computer-readable media, computer programs, products, and other systems that include the system.

Implementations can include some, none, or all of the following features. For at least one container, identifying starting and ending locations comprises: identifying geographic areas for each container; identifying overlap areas with other container areas that overlap; identifying distances between non-overlapping areas; selecting a starting point based on the overlap areas and the distances; and selecting an ending point based on the overlap areas and the distances. The operations further comprise: determining a first cost of the logistics route; determining a second logistics route that does not account for containerization of the items in the containers; finding a second cost of the second logistics route; determining a difference between the second cost and the first cost to represent a cost of containerization; if the cost of containerization is greater than a threshold value: reporting the cost of containerization; and/or proposing a proposed logistics route that violates the containerization constraint and has a third cost lower than the first cost. The operations further comprise: identifying geographic areas for each container; identifying overlap areas with other container areas that overlap; identifying distances between non-overlapping areas; determining, based on the based on the overlap areas and the distances, an order of the sub-routes in the logistics routes.

Various embodiments may optionally provide one or more advantages over prior logistics planning systems. For example, the disclosed technology can determine optimal logistics plans that include one or more operational constraints, such as group sequences. Such optimal logistics plans can permit for existing logistics systems to be improved upon without having to uproot and change existing systems-permitting for the same bin-based planning and delivery to be performed, but with better route planning to permit for all bins to be delivered more efficiently (e.g., faster, less distance travelled, lowest cost). In another example, anomalies can be detected and corrected within existing operational constraints to further permit for optimal route determination, even where the operational constraints imposed on the disclosed technology would lead to highly inefficient outcome. For instance, instead of simply taking all operational constrains as a given, anomalies in the operational constraints (e.g., item groupings in bins, bin sequencing) can be identified that will cause significant inefficiencies and can be corrected, thus ensuring optimal route planning in spite of inefficient operational constraints.

### DESCRIPTION OF DRAWINGS

FIG. 1A shows a flowchart of an example process for optimized logistics planning with one or more operational constraints.

FIG. 1B shows a flowchart of an example process for generating logistics routes.

FIG. 2 shows a flowchart of an example process for determining starting and ending points for logistics routes.

FIG. 3 shows a map representing data useful for determining starting and ending points for logistics routes.

FIG. 4 shows a flowchart of an example process for determining anomalies in logistics routes.

FIG. 5 shows a map representing data useful for determining anomalies in logistics routes.

FIG. 6 shows a flowchart of an example process for reorganizing sub-routes used to create a logistics route.

FIG. 7 shows a map representing data of an inefficient logistics route.

FIG. 8 shows a map representing data of a more efficient logistics route.

FIG. 9 shows a map representing data of a more efficient logistics route.

Like reference symbols in the various drawings indicate like elements

### DETAILED DESCRIPTION

The disclosed technology is generally directed to optimized logistics planning. For example, a vehicle can be loaded with packages to be delivered to customers in a pre-determined configuration, and the order can be irrelevant to the disclosed technology (random, optimized, and/or any loading configuration). The disclosed technology can receive information identifying the physical layout of packages through one or more communication channels (e.g., scanned by mobile app, barcode scanner, loaded through API, typed in manually), and can perform a dynamic grouping logic process, which can include a user interface to obtain user input regarding parameters for optimization (e.g., group size, shelf/bin/container designations, routing preferences); an algorithm to breakdown designated shelf/bin/container takes parameters and creates N number of groupings; and N groupings are passed to routing solver in order to create an optimal pathway (e.g., pathing algorithm takes into account the end of group 2 has to be the start of group 3); and output of grouping and pathing algorithms can be scenarios for delivery path, estimated miles, and/or others.

In another example, the disclosed technology can include anomaly detection and/or outlier control, which can include anomaly detection on output from the previous process in order to make recommendations of stops that should be moved to another group but will cause some operational cost since it's out of shelf/bin/container order. Such recommendations can be presented to the user with miles saved that will allow user feedback to determine if the savings is worth the operational complexity. Anomaly detection can be based on, for example, unconstrained route optimization process that determines the routing if operational constraints were not a factor

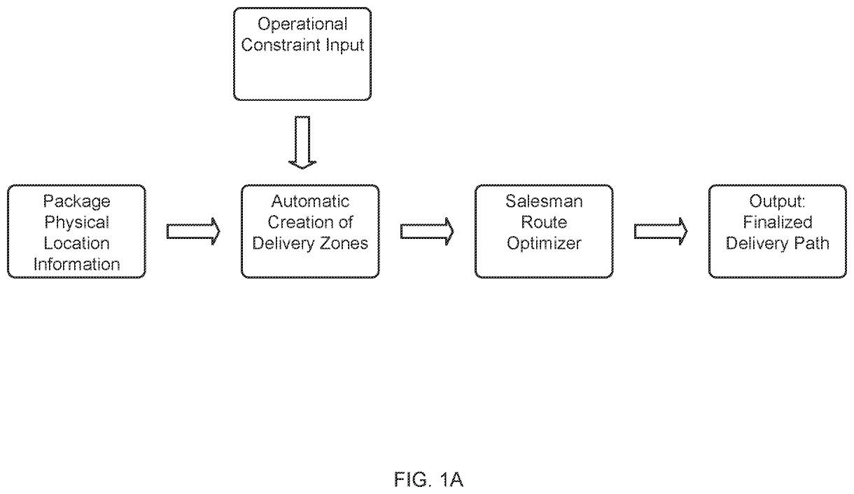

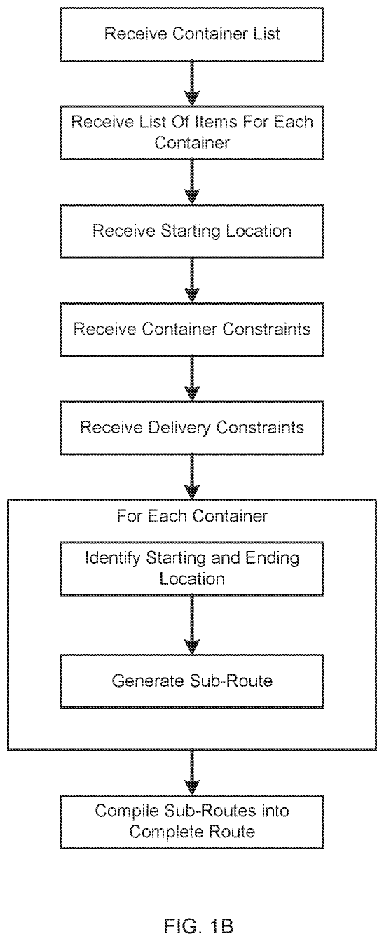

FIG. 1A shows a flowchart of an example process for optimized logistics planning with one or more operational constraints. In the depicted example, package physical location information and operation constraint inputs are taken as inputs to an automatic delivery zone creation process. The package physical location information can include, for example, the location of packages on a vehicle (e.g., truck, boat, plane, autonomous vehicle), the package details with regard to particular groups (e.g., bins, shelves, containers holding packages), and/or other physical location information. The operational constrains can include, for example, a specified bin sequence, a selected optimized bin sequence, vehicle constraints for bins/shelves, and/or other constraints.

The automatic delivery zone creation process can create groups of packages based on the operational constraints, and can generated recommendations for the start and end points from each zone to the next zone. Such recommendations can be generated, for example, based on zones of overlap and/or tangential proximity between geographic zones associated with each bin/shelf. These delivery zones can be created based on groupings of packages based on operational constraints (e.g., the physical shape of a vehicle may allow only particular boxes to be removed when full, and this constrained can be encoded into a rule-set usable by a computer system). Recommendations of start and end points for each zone to the next zone can be based on polygon zone overlap or tangential proximity.

Using the starting and end points for each zone, a salesman route optimizer can be run for each zone to determine the optimal route through each zone (with the designated starting and ending points).

A finalized and optimal delivery path can then be output by combining the optimal routes within each zone and daisy chaining the routes together.

FIG. 1B shows a flowchart of an example process for generating logistics routes. This process can be used to generate logistics routes for a vessel full of items that cannot all be accessed at the same time. For example, a trailer may be loaded with pallets in such a way that only the boxes in the pallets at the back can be accessed. This process can generate a logistics route to deliver all the boxes in the trailer in an order that clears available boxes before attempting to deliver the previously-inaccessible boxes.

A list of containers is received. For example, data describing the number and arrangement of physical bins, bags, shelves, bottles, pallets etc. on a vessel (e.g., truck, van, trailer, railcar, boat, ship, and/or airplane) can be received by a computer system. This data and other data may be stored in computer memory, transmitted across computer networks, etc.

A list of items for each container is received. For example, the computer system can receive data indicating which physical items are actually stored in identified container, or which items are scheduled to be loaded into the corresponding containers.

A starting location is received. For example, a vessel may begin travel from a distribution center or manufacturing location where the vessel is loaded. In another example, the vessel may begin travel from a motor pool, dock or parking area where the vessel is stored when not in use.

Constraint data is received for containers. For example, the computer system may receive information specifying the availability constraints of containers in the vessel. In the case of a van having four shelves, shelf number 3 may be inaccessible until shelf number 1 is empty and shelf number 4 may be inaccessible until shelf number 2 is empty. In the case of a tanker ship, the ship may have four holding tanks and must follow a “first in first out” (aka FIFO) system where the oldest tank must be unloaded first.

Constraint data is received for deliveries. For example, some items may be recorded in the data as requiring delivery in a particular time window, in a particular order, etc.

For each container, a sub-route is created. For example, the sub-route may be a route that the vessel can traverse to deliver each item in the container being examined. This route may have a starting location and an ending location set by another part of the process (e.g., starting at a manufacturer's location, ending in a parking lot elsewhere, and/or the start of this sub-route may be the ending point of another sub-route, or vice versa).

A complete logistics route is compiled from the sub-routes. For example, the computer system can arrange the sub-routes in order to create a logistics route that, when traversed, will deliver every item in the vessel.

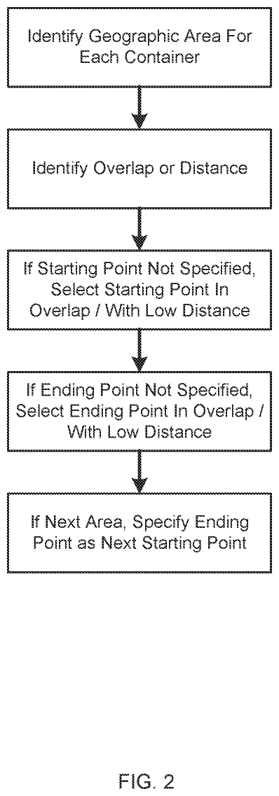

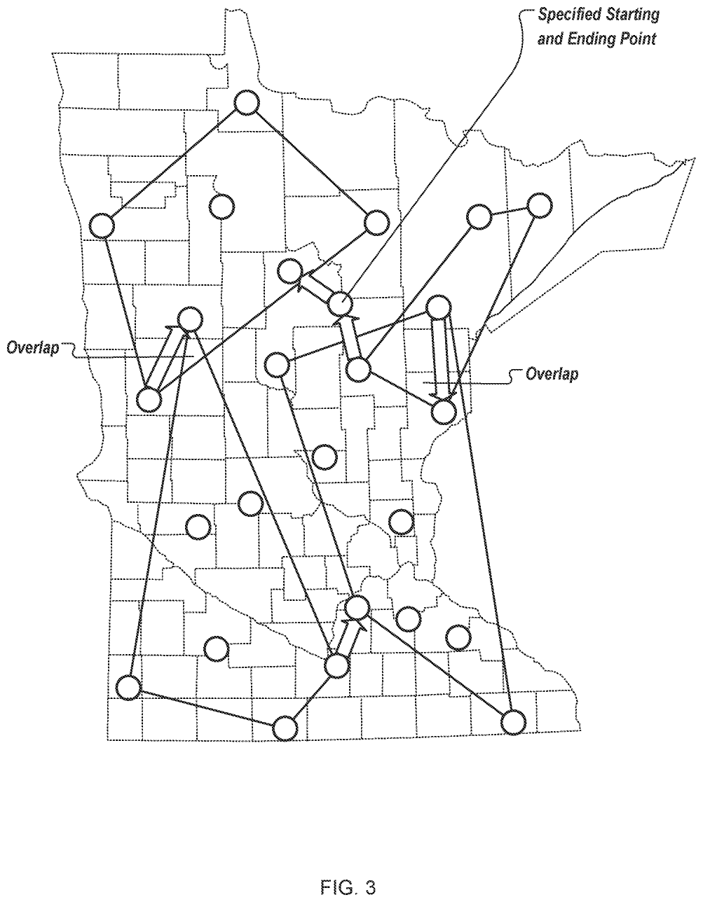

FIG. 2 shows a flowchart of an example process for determining starting and ending points for logistics routes. FIG. 3 shows a map representing data useful for determining starting and ending points for logistics routes. This process can be used to arrange the sub-routes into a single logistics route that accounts for the transitions from sub-route to sub-route.

A geographic area for each container is identified. For example, on a map, the delivery location for each item may be determined. A polygon encapsulating the each delivery location may be found for each container. This is shown graphically here, but it will be understood that such graphical showing is not required.

Areas of overlap are identified. For example, the computer can compare the locations of the polygons, and any area that is within two or more polygons can be identified as an area of overlap. For pairs of polygons that do not overlap, the minimum distance between points (e.g., edges, corners, vertices) of the two polygons can be found. This data can be stored to memory by the computer system.

For each geographic area, a starting point or an ending point may be specified. In the example map shown, a single point is identified as a starting point and ending for the logistics route. This may represent, for example, a distribution center from which a truck is based out of.

If starting and ending points are not specified for each sub-route, starting and ending points may be selected based on areas that overlap and distances between polygons. For example, a solver may select an ordering of sub-routes, starting points, and ending points that minimize some cost function. The cost function can consider financial cost (e.g., gasoline costs, tolls), as well as non-financial costs (e.g., time, wear-and-tear, distance).

Ending points for one sub-route can be set as the starting points of the next sub-route. For example, sub-route A's last stop represents the location of the truck when sub-route A is completed. This is where the truck is when sub-route B is beginning. By selecting areas of overlap and considering distances between polygons, the transition cost (e.g. time, financial cost) between sub-routes can be reduced, minimized, or eliminated.

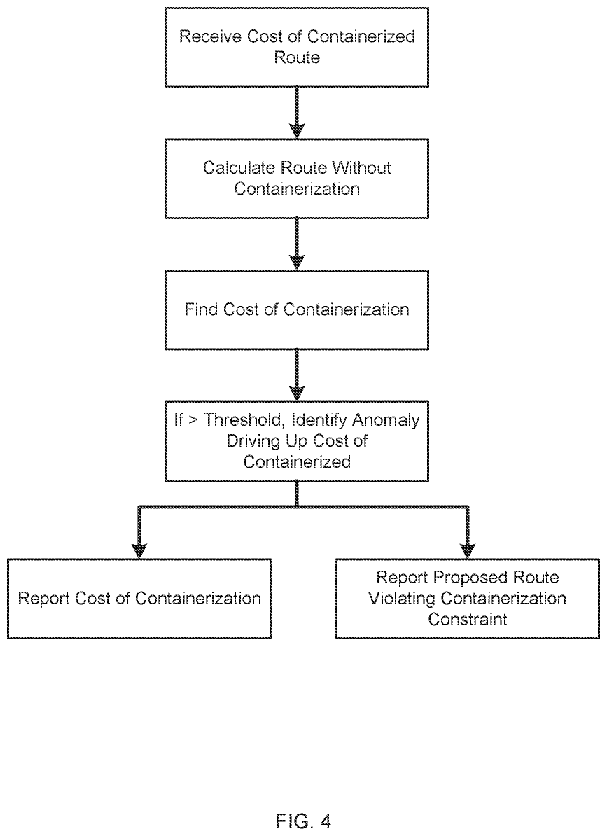

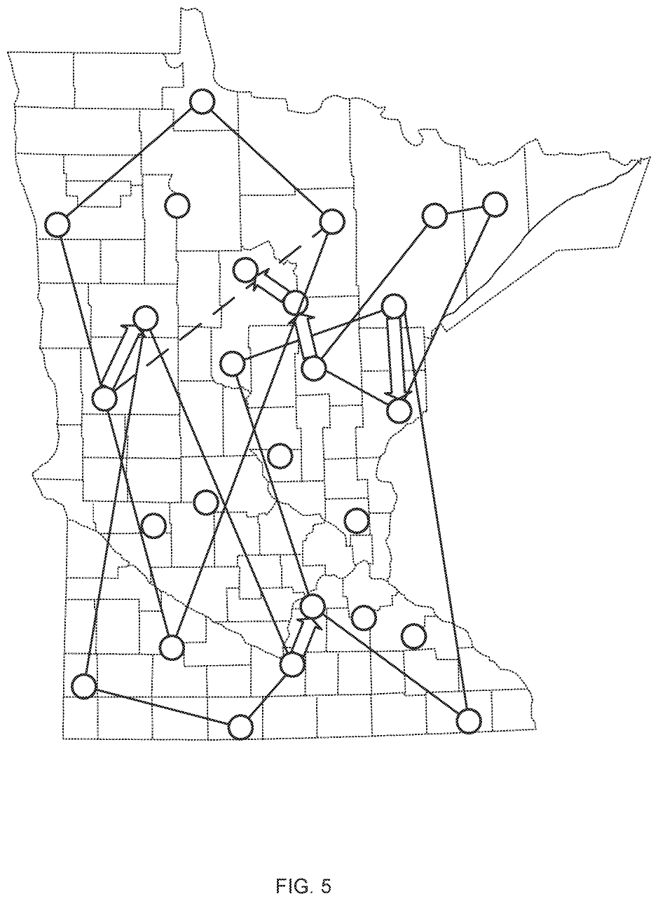

FIG. 4 shows a flowchart of an example process for determining anomalies in logistics routes. FIG. 5 shows a map representing data useful for determining anomalies in logistics routes. This process can be used to identify anomalies—items in containers that greatly increase the cost of a logistics route. For example, if a first container has items that are all to be delivered on the east side of a city and a second container has items that area all to be delivered on the west side of a city, one item in the second container being reassigned to the east side of the city could greatly increase the cost of delivering the items.

The cost of a first containerized logistics route is received by the computer system. For example, this cost may be one or more parameters estimated for a logistics route as described with reference to FIG. 1B. As previously described, the cost may include financial considerations as well as non-financial considerations.

A second logistics route is determined that does not apply the container constraints used in the generation of the first logistics route. That is, this is a route that would be possible if every item on the vessel was available to delivery no matter where it is in the vessel and no matter what other items are on the vessel. As will be understood, such an unconstrained second route can have a cost equal to or less than the cost of the constrained first route.

The cost of the unconstrained second route can be found and compared with the cost of the constrained first route. This difference can be used as a measure of the cost of the constraints imposed by the physical structure of the vessel, by the business logic that requires delivery in particular orders, etc.

If this cost is greater than a threshold value, the first route may be examined to identify one or more anomalies. For example, the one package reassigned to the east side of town may be considered an anomaly due to the reassignment being stored in computer memory. In another example, the geometry of each polygon for each sub-route may be examined to identify anomalies. Such a geographic analysis may include determining the distance of each stop from a centroid of the polygon and identifying any distances that are much greater than for other stops. Another geographic analysis may include “with or without you” analysis in which each polygon is compared to hypothetical polygons that exclude one stop to find large disparities. Another geographical analysis may include searching for acute angles lower than a threshold angle.

If an anomaly is detected, one or more remediations can be recorded in computer memory. One example remediation is the generation of a report or graphic user interface reporting the anomaly to a human user that is able to correct the anomaly. For example, the driver, when loading his truck, may reorganize his load so that the east-destined package is placed in the same bin as the other east-destined packages. Another remediation that may be used in addition or instead is to move the stop for that package into another sub-route, even if the physical package is not moved to another container. That is, the final logistics route may call for a stop to deliver a package that is not immediately accessible. This may require the driver to spend some time unloading a container to access the otherwise-inaccessible package, then reload the container. Nevertheless, depending on the anomaly, such unloading-and-reloading may still be less costly than, for example, two extra cross-town trips during rush hour.

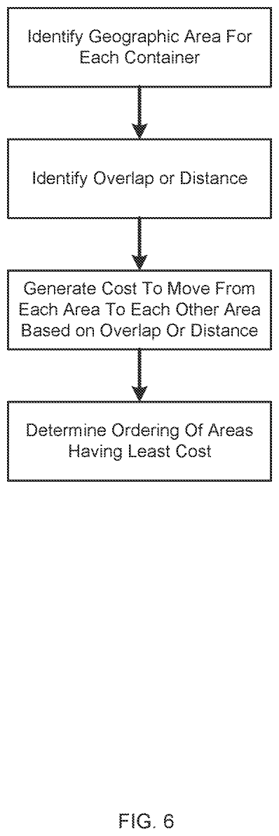

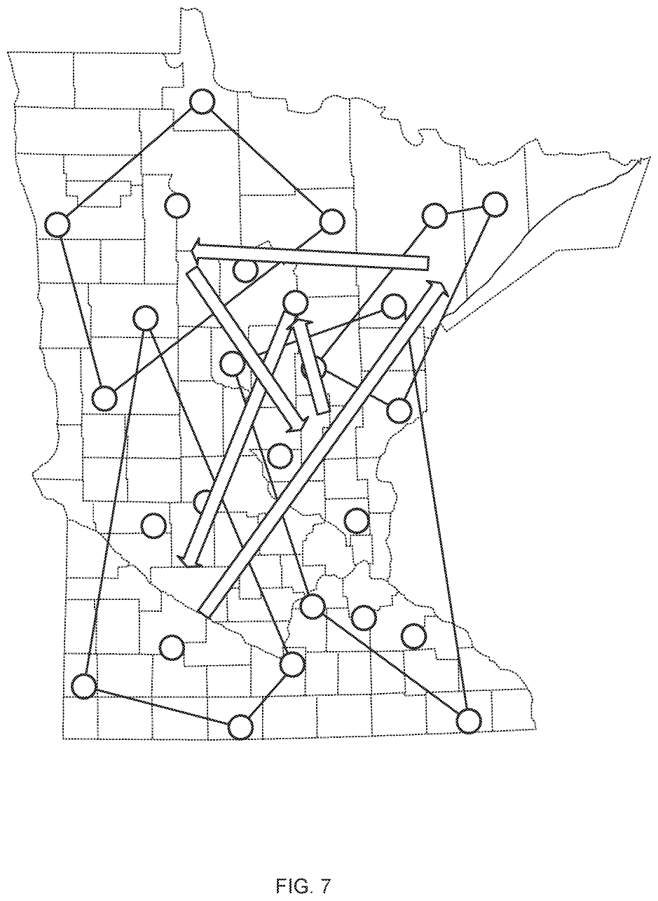

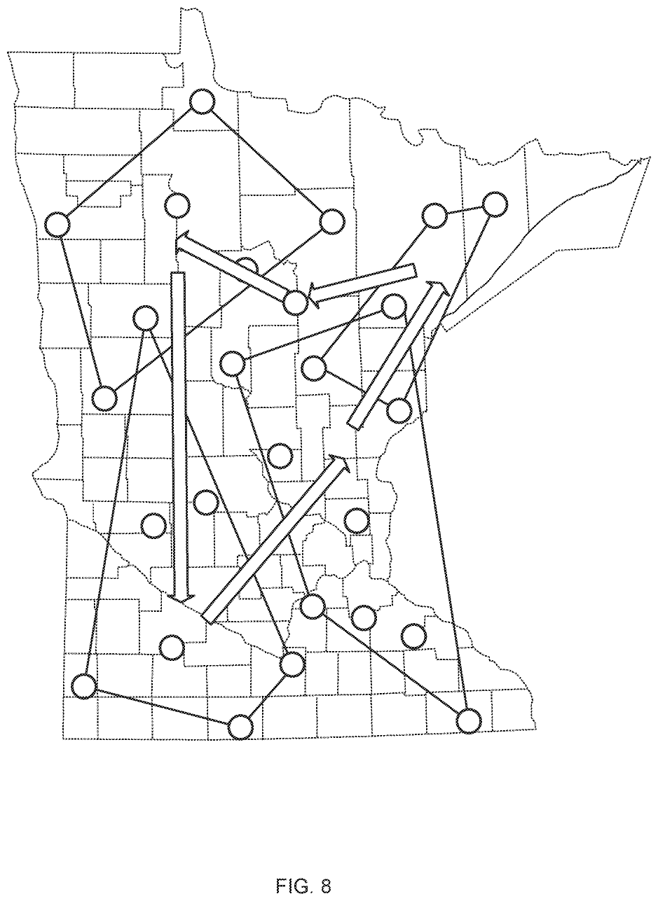

FIG. 6 shows a flowchart of an example process for reorganizing sub-routes used to create a logistics route. FIG. 7 shows a map representing data of an inefficient logistics route. FIG. 8 shows a map representing data of a more efficient logistics route. The process of FIG. 6 may be used to transform data specifying the route of FIG. 7 into data specifying the more efficient route of FIG. 8

In general, the logistics route shown in FIG. 7 is created in a way that incurs high costs when moving from sub-route to sub-route, but low costs when within a sub-route. Data representing the logistics route of FIG. 7 and/or corresponding data used to generate the route is received by a computer system.

The computer system identifies geographic areas for each container and/or for each sub-route. Areas of overlap and distances between non-overlapping areas are identified. For example, see above.

A transition cost to represent the cost to move from each area to each other area is found. For example, the computer system can list every ordered pair of areas, and can calculate a cost to travel from the first element of the ordered pair to the second element of the ordered pair. This cost can be generated using the overlapping areas and the distances between non-overlapping areas.

An ordering of the areas can be found that has the least cost, or a lower cost than the cost of the initial logistics route. For example, a solver can treat area as a node in a directed graph, with each edge having a weight specified by the cost found above. The solver then may find the least-cost path that traverses every node.

A number of flowcharts and data schemes have been described here. It should be understood that each may be used independently or in various combinations. In addition, optional elements have been described, and may be excluded, depending on the configuration of the technology.

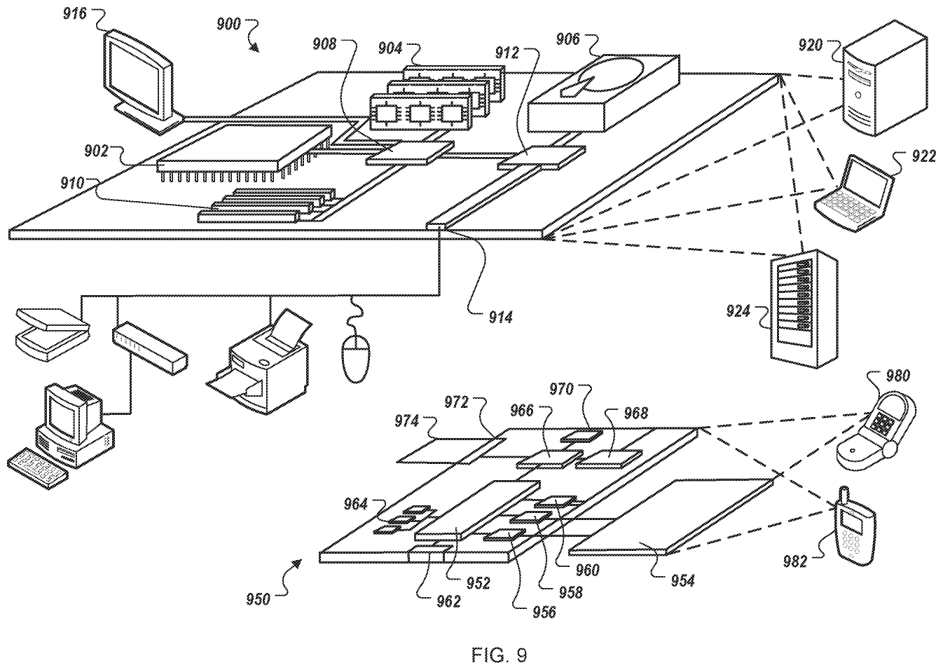

FIG. 9 shows an example of a computing device 900 and an example of a mobile computing device that can be used to implement the techniques described here. The computing device 900 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and can be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 can also be another form of computer-readable medium, such as a magnetic or optical disk.

The storage device 906 is capable of providing mass storage for the computing device 900. In some implementations, the storage device 906 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 904, the storage device 906, or memory on the processor 902.

The high-speed interface 908 manages bandwidth-intensive operations for the computing device 900, while the low-speed interface 912 manages lower bandwidth-intensive operations. Such allocation of functions is exemplary only. In some implementations, the high-speed interface 908 is coupled to the memory 904, the display 916 (e.g., through a graphics processor or accelerator), and to the high-speed expansion ports 910, which can accept various expansion cards (not shown). In the implementation, the low-speed interface 912 is coupled to the storage device 906 and the low-speed expansion port 914. The low-speed expansion port 914, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 900 can be implemented in a number of different forms, as shown in the figure. For example, it can be implemented as a standard server 920, or multiple times in a group of such servers. In addition, it can be implemented in a personal computer such as a laptop computer 922. It can also be implemented as part of a rack server system 924. Alternatively, components from the computing device 900 can be combined with other components in a mobile device (not shown), such as a mobile computing device 950. Each of such devices can contain one or more of the computing device 900 and the mobile computing device 950, and an entire system can be made up of multiple computing devices communicating with each other.

The mobile computing device 950 includes a processor 952, a memory 964, an input/output device such as a display 954, a communication interface 966, and a transceiver 968, among other components. The mobile computing device 950 can also be provided with a storage device, such as a micro-drive or other device, to provide additional storage. Each of the processor 952, the memory 964, the display 954, the communication interface 966, and the transceiver 968, are interconnected using various buses, and several of the components can be mounted on a common motherboard or in other manners as appropriate.

The processor 952 can execute instructions within the mobile computing device 950, including instructions stored in the memory 964. The processor 952 can be implemented as a chipset of chips that include separate and multiple analog and digital processors. The processor 952 can provide, for example, for coordination of the other components of the mobile computing device 950, such as control of user interfaces, applications run by the mobile computing device 950, and wireless communication by the mobile computing device 950.

The processor 952 can communicate with a user through a control interface 958 and a display interface 956 coupled to the display 954. The display 954 can be, for example, a TFT (Thin-Film-Transistor Liquid Crystal Display) display or an OLED (Organic Light Emitting Diode) display, or other appropriate display technology. The display interface 956 can comprise appropriate circuitry for driving the display 954 to present graphical and other information to a user. The control interface 958 can receive commands from a user and convert them for submission to the processor 952. In addition, an external interface 962 can provide communication with the processor 952, so as to enable near area communication of the mobile computing device 950 with other devices. The external interface 962 can provide, for example, for wired communication in some implementations, or for wireless communication in other implementations, and multiple interfaces can also be used.

The memory 964 stores information within the mobile computing device 950. The memory 964 can be implemented as one or more of a computer-readable medium or media, a volatile memory unit or units, or a non-volatile memory unit or units. An expansion memory 974 can also be provided and connected to the mobile computing device 950 through an expansion interface 972, which can include, for example, a SIMM (Single In Line Memory Module) card interface. The expansion memory 974 can provide extra storage space for the mobile computing device 950, or can also store applications or other information for the mobile computing device 950. Specifically, the expansion memory 974 can include instructions to carry out or supplement the processes described above, and can include secure information also. Thus, for example, the expansion memory 974 can be provide as a security module for the mobile computing device 950, and can be programmed with instructions that permit secure use of the mobile computing device 950. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 964, the expansion memory 974, or memory on the processor 952. In some implementations, the computer program product can be received in a propagated signal, for example, over the transceiver 968 or the external interface 962.

The mobile computing device 950 can communicate wirelessly through the communication interface 966, which can include digital signal processing circuitry where necessary. The communication interface 966 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 968 using a radio-frequency. In addition, short-range communication can occur, such as using a Bluetooth, WiFi, or other such transceiver (not shown). In addition, a GPS (Global Positioning System) receiver module 970 can provide additional navigation- and location-related wireless data to the mobile computing device 950, which can be used as appropriate by applications running on the mobile computing device 950.

The mobile computing device 950 can also communicate audibly using an audio codec 960, which can receive spoken information from a user and convert it to usable digital information. The audio codec 960 can likewise generate audible sound for a user, such as through a speaker, e.g., in a handset of the mobile computing device 950. Such sound can include sound from voice telephone calls, can include recorded sound (e.g., voice messages, music files, etc.) and can also include sound generated by applications operating on the mobile computing device 950.

The mobile computing device 950 can be implemented in a number of different forms, as shown in the figure. For example, it can be implemented as a cellular telephone 980. It can also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A system for determining a logistics route comprising:
one or more processors;
computer memory storing instructions that, when run by the processors, cause the processors to perform operations comprising:
receiving a list of containers that each contain items;
receiving a list of the items and, for each item, data specifying which of the containers contains the item;
receiving a starting location;
receiving container constraints that specify at least one condition in which at least one container is inaccessible;
receiving delivery constraints that specify at least one condition that must be true for at least one item to be delivered;
for each container:
identifying starting and ending locations; and
generating a sub-route corresponding to the container that specifies a delivery route to be followed to deliver each item in the container; and
compiling the sub-route for each container into a logistics route specifying a route a delivery route to be followed to deliver all items in all containers.

2. The system of claim 1, wherein for at least one container, identifying starting and ending locations comprises:
identifying geographic areas for each container;
identifying overlap areas with other container areas that overlap;
identifying distances between non-overlapping areas;
selecting a starting point based on the overlap areas and the distances; and
selecting an ending point based on the overlap areas and the distances.

3. The system of claim 2, wherein:
identifying geographic areas for each container comprises storing a collection of geolocations in the computer memory and using those geolocations as vertices of polygons;
identifying overlap areas with other container areas that overlap by comparing the geolocations of a first polygon with other polygons to determine if the geolocation is contained within another polygon; and
identifying distances between non-overlapping areas by determining distances between one of the group consisting of i) the geolocations, ii) polygon-edges identified between pairs of geolocations of a polygon.

4. The system of claim 3, wherein the identifying geographic areas for each container comprises storing a collection of geolocations in the computer memory and using those geolocations as vertices of polygons is performed without a graphical showing of the polygons to a user.

5. The system of claim 1, wherein the operations further comprise:
determining a first cost of the logistics route;
determining a second logistics route that does not account for containerization of the items in the containers;
finding a second cost of the second logistics route;
determining a difference between the second cost and the first cost to represent a cost of containerization.

6. The system of claim 5, wherein the operations further comprise:
generating a proposed logistics route that violates the containerization constraint and has a third cost lower than the first cost
displaying, to a user, the cost of containerization; and
receiving, from the user and in response to displaying to the user the cost of containerization, input selecting one of the group consisting of the logistics route and the proposed logistics route.

7. The system of claim 5, wherein the operations further comprise:
if the cost of containerization is greater than a threshold value:
reporting the cost of containerization; and/or
proposing a proposed logistics route that violates the containerization constraint and has a third cost lower than the first cost.

8. The system of claim 1, wherein the operations further comprise:
identifying geographic areas for each container;
identifying overlap areas with other container areas that overlap;
identifying distances between non-overlapping areas;
determining, based on the overlap areas and the distances, an order of the sub-routes in the logistics routes.

9. The system of claim 1, wherein the operations further comprise:
generating graph-data stored in the computer memory to represent a graph comprising nodes and edges;
storing in the graph-data identifications that correlate a node in the graph with a geographic area for each container;
for each ordered pair of nodes, storing in the graph-data a weight value to represent a cost for that edge in a logistics route;
wherein generating the sub-route corresponding to the container that specifies a delivery route to be followed to deliver each item in the container comprises
submitting, to a solver configured to solve for least-cost paths through a graph, the graph-data as input; and
receiving, from the solver, a least-cost path through the graph-data.

10. A method for determining a logistics route comprising:
receiving, by a computing system, a list of containers that each contain items;
receiving, by the computing system, a list of the items and, for each item, data specifying which of the containers contains the item;
receiving, by the computing system, a starting location;
receiving, by the computing system, container constraints that specify at least one condition in which at least one container is inaccessible;
receiving, by the computing system, delivery constraints that specify at least one condition that must be true for at least one item to be delivered;
for each container, by the computing system:
identifying starting and ending locations; and
generating a sub-route corresponding to the container that specifies a delivery route to be followed to deliver each item in the container; and
compiling, by the computing system, the sub-route for each container into a logistics route specifying a route a delivery route to be followed to deliver all items in all containers.

11. The method of claim 10, wherein for at least one container, identifying starting and ending locations comprises:
identifying geographic areas for each container;
identifying overlap areas with other container areas that overlap;
identifying distances between non-overlapping areas;
selecting a starting point based on the overlap areas and the distances; and
selecting an ending point based on the overlap areas and the distances.

12. The method of claim 11, wherein:
identifying geographic areas for each container comprises storing a collection of geolocations in the computer memory and using those geolocations as vertices of polygons;
identifying overlap areas with other container areas that overlap by comparing the geolocations of a first polygon with other polygons to determine if the geolocation is contained within another polygon; and
identifying distances between non-overlapping areas by determining distances between one of the group consisting of i) the geolocations, ii) polygon-edges identified between pairs of geolocations of a polygon.

13. The method of claim 12, wherein the identifying geographic areas for each container comprises storing a collection of geolocations in the computer memory and using those geolocations as vertices of polygons is performed without a graphical showing of the polygons to a user.

14. The method of claim 10, wherein the method further comprises:
determining a first cost of the logistics route;
determining a second logistics route that does not account for containerization of the items in the containers;
finding a second cost of the second logistics route;
determining a difference between the second cost and the first cost to represent a cost of containerization.

15. The method of claim 14, wherein the method further comprises:
generating a proposed logistics route that violates the containerization constraint and has a third cost lower than the first cost
displaying, to a user, the cost of containerization; and
receiving, from the user and in response to displaying to the user the cost of containerization, input selecting one of the group consisting of the logistics route and the proposed logistics route.

16. The method of claim 14, wherein the method further comprises:
if the cost of containerization is greater than a threshold value:
reporting the cost of containerization; and/or
proposing a proposed logistics route that violates the containerization constraint and has a third cost lower than the first cost.

17. The method of claim 10, wherein the method further comprises:
identifying geographic areas for each container;
identifying overlap areas with other container areas that overlap;
identifying distances between non-overlapping areas;
determining, based on the overlap areas and the distances, an order of the sub-routes in the logistics routes.

18. The method of claim 10, wherein the method further comprises:
generating graph-data stored in the computer memory to represent a graph comprising nodes and edges;
storing in the graph-data identifications that correlate a node in the graph with a geographic area for each container;
for each ordered pair of nodes, storing in the graph-data a weight value to represent a cost for that edge in a logistics route;
wherein generating the sub-route corresponding to the container that specifies a delivery route to be followed to deliver each item in the container comprises
submitting, to a solver configured to solve for least-cost paths through a graph, the graph-data as input; and
receiving, from the solver, a least-cost path through the graph-data.

19. A non-transitory computer-readable medium tangibly storing instructions that, when run by one or more processors, cause the processors to perform operations comprising:
receiving a list of containers that each contain items;
receiving a list of the items and, for each item, data specifying which of the containers contains the item;
receiving a starting location;
receiving container constraints that specify at least one condition in which at least one container is inaccessible;
receiving delivery constraints that specify at least one condition that must be true for at least one item to be delivered;
for each container:
identifying starting and ending locations; and
generating a sub-route corresponding to the container that specifies a delivery route to be followed to deliver each item in the container; and
compiling the sub-route for each container into a logistics route specifying a route a delivery route to be followed to deliver all items in all containers.

20. The system of claim 1, wherein for at least one container, identifying starting and ending locations comprises:
identifying geographic areas for each container;
identifying overlap areas with other container areas that overlap;
identifying distances between non-overlapping areas;
selecting a starting point based on the overlap areas and the distances; and
selecting an ending point based on the overlap areas and the distances.
